(19) United States
(12) Patent Application Publication
(10) Pub. No.: US 2005/0075457 A1
(43) Pub. Date: Apr. 7, 2005

(54) Propylene polymers having agreeable odor characteristics and shaped articles thereof

(75) Inventors: Stefan U. Koschmieder, Arlington, VA (US); Peter Frenkel, Longview, TX (US); Ted M. Pettijohn, Avon, OH (US)

Correspondence Address: Michael P. Dilworth;CROMPTON CORPORATION, Benson Road, Middlebury, CT, 06749, US

(73) Assignee: CROMPTON CORPORATION, a corporation of the State of Delaware

(21) Appl. No.: 11/000,546

(22) Filed: Nov. 30, 2004

Related U.S. Application Data
(62) Division of application No. 09/911,177, filed on Jul. 23, 2001.
(60) Provisional application No. 60/222,857, filed on Aug. 4, 2000.

(51) Int. Cl. C08F 8/00

(52) U.S. Cl. 525/191

(57) ABSTRACT

A polymer composition is disclosed that comprises a propylene polymer having a melt flow index in the range from 4 to 120 decigrams/minute, di-t-amyl peroxide, and at least one decomposition product of said peroxide, whereby said composition has agreeable odor characteristics.

This application is a division of U.S. application Ser. No. 09/911,177 filed Jul. 23, 2001, for which the benefits under Title 35, United States Code § 120 of U.S. Provisional Application No. 60/222,857, filed Aug. 4, 2000, entitled “Propylene Polymers Having Agreeable Odor Characteristics and Shaped Articles Thereof” have been claimed.

### BACKGROUND OF THE INVENTION

1. Field of the Invention

The present invention is directed to controlled rheology polymers having improved odor characteristics. More specifically, the present invention is directed to compositions having agreeable odor characteristics comprising a propylene polymer having a melt flow index in the range from 4 to 120 decigrams/minute, di-t-amyl peroxide, and at least one decomposition product thereof.

2. Description of Related Art

The physical properties of polypropylene resins provide several benefits for applications in food, drug, and cosmetic applications. In comparison to polymeric materials such as PET, polypropylene has a lower specific gravity allowing for cost savings in some applications owing to the lower quantity of material required. Good temperature resistance permits polypropylene to be used for “hot filled” liquid containers. Additionally, low moisture vapor transmission makes polypropylene ideal for packaging applications requiring dry environment storage. While the clarity of polypropylene resins do not yet match the clarity offered by polystyrene materials, visual inspection of the packaging contents is still possible. This is an important benefit for some consumer applications and applications such as medical syringes where the ability to perform a visual volume determination is crucial.

The end use applications for polypropylene are myriad. Polypropylene is often used in consumer applications, such as small appliances (for example, coffee machines and personal coolers). Properties such as lightness, resistance to cracking, thermal resistance, and ease of processing make this material ideal for many uses that directly impact the consumer.

In the medical industry, polypropylene is perhaps best recognized as the material of choice for disposable syringes. Polypropylene's ability to undergo steam and radiation sterilization without premature degradation is a vital element of this material's success in medical applications. Polypropylene is also used in medical packaging applications such as the storage of intravenous fluids and specimens.

Ease of processing in blow molding, injection molding, and thermoforming operations makes polypropylene an ideal material for manufacturing the rigid containers often associated with food use. High heat resistance is exploited in applications where precooked meals are supplied in polypropylene containers that are heated in microwave ovens. The polypropylene allows a hot meal to be warmed and served in an inexpensive disposable container that retains its rigidity during the heating cycle.

Biaxially oriented polypropylene films (BOPP) have seen widespread use in the snack and bakery markets. The low vapor transmission characteristic of polypropylene keeps baked goods moist and fresh in appearance. Snack foods, such as potato chips and chocolate candies, are often packaged in opaque bags manufactured from a combination of BOPP and low oxygen permeability films. Importantly, the high printability of polypropylene films offers the food vendor an opportunity to uniquely label and mark the food product.

Special requirements regarding safety and performance command a price premium in the resin market. The performance attributes described above for polypropylene permit this resin to be successfully marketed to high-value FDA regulated end uses. Organoleptics present after final manufacture of the resin may affect odor and taste characteristics. These unwanted chemical inclusions have to be carefully controlled. Resin formulations are affected not only by the end user's subjective odor/taste perception but also by regulatory agencies. In the United States, this function is performed by the FDA, which closely regulates the additives that are permitted in food and drug applications. Additives that can negatively impact odor and taste (for example, thioesters) are generally avoided in resin formulations for food applications.

Many of the end-use applications require resins with specific melt flow characteristics. In most cases, high melt flow material is manufactured from a basic polypropylene resin with low melt flow. This process of rheology modification is usually accomplished through a reactive extrusion technique known as viscosity breaking (vis-breaking). The method of processing a controlled rheology resin involves the extrusion of a polypropylene base resin of known melt flow characteristics in the presence of an organic peroxide. The decomposition of the organic peroxide at extruder temperatures yields a radical species that chemically degrades the polymer backbone in a “beta scission” process. This process can be precisely controlled by adjusting the amount of peroxide added to the resin during extrusion. The consistent and predictable results obtained through this process add an extra degree of flexibility to the manufacturing process. This allows large quantities of low melt flow polypropylene to be tailored to various higher melt ranges.

The organic peroxide most widely used to produce controlled rheology polypropylene is 2,5-dimethyl 2,5-di-t-butylperoxyhexane (DTBPH). The decomposition of this peroxide yields several organic species as by-products, including t-butyl alcohol (TBA), acetone, methane, as well as others. The FDA regulates TBA. The upper limit of TBA concentration allowed in food grade applications is 100 ppm. TBA has an astringent “chemical” odor that affects the odor and taste characteristics of the final resin. Not only does the TBA affect odor/taste performance, it also impacts the salability of the resin into high-value markets. If TBA is present at concentrations higher than 100 ppm, the polypropylene may not be used in food grade applications, as per FDA regulation (21 CFR 177.1520).

As an additive, DTBPH is regulated by the FDA. Additionally a special limitation applies for residual TBA. An organic peroxide that does not yield FDA regulated decomposition products, and does not negatively impact the odor/taste characteristics of the propylene polymer, would eliminate the difficulties associated with meeting a TBA target while at the same time offer the polypropylene industry a tool for manufacturing a highly marketable resin.

U.S. Pat. No. 3,144,436 discloses a process for improving the processability of high molecular weight stereoregular hydrocarbon polymers which comprises treating the said polymer melt in the essential absence of oxygen in a screw extruder, at the temperature of from the polymer melting point to 100° C. above its melting point, with 0.005-0.5 weight percent of a free radical initiator until the melt index of the resulting stereoregular product is increased from the range “no-flow”−10 to 0.1-100, under the conditions of A.S.T.M. Test No. D-1238-57T Condition E, with the amount of oxygen introduced into the polymer during the process being less than 0.2% of the total weight.

U.S. Pat. No. 3,887,534 discloses a method for modification of crystalline propylene polymer which comprises heating a mixture comprising 100 parts by weight of said polymer and 0.001 to 0.5 part by weight of an aliphatic peroxide at a temperature of from 170 to 280° C. to diminish the molecular weight of said polymer whereby its processability is much improved, said peroxide having a half life time of from 2.0 to 10.0 hours at 130° C. and vapor pressure of not more than 760 mm Hg at 230° C.

U.S. Pat. No. 3,940,379 discloses a process for the degradation of propylene polymers comprising contacting a propylene polymer exhibiting a first melt flow rate with oxygen or an oxygen-containing gas and an organic or inorganic peroxide; melting and working the resulting mixture in a high shear zone thereby degrading said propylene polymer; and recovering an essentially odor free propylene polymer exhibiting a second melt flow rate higher than said first melt flow rate.

U.S. Pat. No. 4,271,279 discloses high density polyethylene cross-linked with certain cyclic perketals including a group of novel cyclic perketals. Typical of the novel molecules is 3,6,6,9,9-pentamethyl-3-ethylacetate-1,2,4,5-tetraoxy cyclononane.

U.S. Pat. No. 4,451,589 discloses a specific class of thermoplastic polymers that are said to exhibit improved processability resulting from initial partial degradation of high molecular weight polymers using a chemical prodegradant present in excess of the amount reacted during pelletization. This class of polymers includes polymers and copolymers of polypropylene and butylene. After pelletizing, the polymer including unreacted prodegradant can be safely handled and shipped without difficulty. When remelted by extruding or the like, the prodegradant in the pellets reacts, further reducing the molecular weight as well as narrowing the molecular weight distribution of the polymer to a point where high capacity production of quality fibers and extruded products can be obtained. The prodegradant is preferably of the type that predictably and controllably affects the polymer molecular properties without being significantly affected by minor fluctuations in the polymer producer's or processor's manufacturing steps. Specific preferred embodiments include 2,5-dimethyl-2,5 bis-(t-butylperoxy) hexyne-3; 3,6,6,9,9-pentamethyl-3-(ethyl acetate)-1,2,4,5-textraoxy cyclononane; α,α′-bis (t-butylperoxy) diispropyl benzene and 2,5-dimethyl-2,5-di (t-butylperoxy) hexane as the prodegradant added in an amount providing an amount of unreacted prodegradant after pelletizing of about 0.01 to 10.0 percent based on the weight of polymer.

U.S. Pat. 4,707,524 discloses small amounts of peroxides that do not decompose to TBA and have a half-life in the range of about 1.0 to 10 hrs. at 128° C. are incorporated in polypropylene by thermal mechanical melting in an extruder. Control of molecular weight and molecular weight distribution is achieved as a function of the amount of peroxide added. The peroxides of choice are 2,2 di(t-amyl) peroxy propane and 3,6,6,9,9 pentamethyl-3 n-propyl-1,2,4,5 tetraoxacyclononane.

The disclosures of the foregoing are incorporated herein by reference in their entirety.

### SUMMARY OF THE INVENTION

In accordance with this invention, there is provided a dialkyl organic peroxide that offers improved organoleptic performance in comparison to the peroxide traditionally used for the controlled rheology reaction of propylene polymers. This peroxide, di-tertiary-amylperoxide (DTAP) effectively modifies polypropylene yielding higher melt flow resins with improved odor characteristics.

More particularly, the present invention is directed to a polymer composition comprising a propylene polymer having a melt flow index in the range from 4 to 120 decigrams/minute, di-t-amyl peroxide, and at least one decomposition product of said peroxide, whereby said composition has agreeable odor characteristics.

In another aspect, the present invention is directed to a method of manufacturing a shaped article comprising the steps of:

A) mixing a propylene polymer having a melt flow index in the range from 1 to 20 decigrams/minute with a vis-breaking amount of di-t-amyl peroxide,

B) heating the mixture at a temperature effective to decompose the di-t-amyl peroxide until the melt flow index is in the range of from 4 to 120 decigrams/minute, and

C) shaping an article comprising a mixture comprising the propylene polymer having a melt flow index in the range from 4 to 120 decigrams/minute, di-t-amyl peroxide, and decomposition products of said peroxide, whereby said article has agreeable odor characteristics.

In still another aspect, the present invention is directed to an improvement in a method for producing a controlled rheology propylene polymer, wherein the improvement comprises employing a vis-breaking amount of t-amyl peroxide to generate free radicals and produce t-amyl alcohol, whereby the pleasantness of the organoleptic qualities of the polymer is increased.

### DESCRIPTION OF THE PREFERRED EMBODIMENTS

Propylene polymers are successfully used for the manufacture of a great variety of shaped articles. Shaped articles in which the agreeable odor characteristics afforded according to this invention are particularly valuable include food contact and medical applications, such as packaging films, candy wrappers, bottles and containers for foods and pharmaceuticals, and medical syringes, for which the physical properties including lightness, resistance to cracking, and thermal resistance, combined with ease of processing and favorable economics make propylene polymers the materials of choice. Particularly preferred are shaped articles characterized by a high surface to volume ratio, such as films, where agreeable odor characteristics are especially important.

As used herein, the term “propylene polymer” is intended to include homopolymeric polypropylene and copolymers of propylene with other copolymerizable monomers wherein the major portion, i.e., greater than about 50% by weight of the copolymer is comprised of propylene moieties. Suitable copolymerizable monomers include, for example, ethylene, butylene, 4-methyl-pentene-1, and the like.

The propylene polymers used in manufacture of shaped articles according to the invention, particularly for packaging applications, are suitably manufactured by controlled rheology techniques where feedstock resins with low melt flow characteristics are modified by a reactive extrusion technique known as viscosity breaking (vis-breaking) to the desired melt flow range. Vis-breaking can be carried out as part of the procedure of compounding the polymer with additives such as antioxidants and colorants, or as a separate process step before or after compounding with additives. A convenient compilation of additives that can be safely used in shaped articles intended for food contact is contained in title 21 of the U.S. Code of Federal Regulations, Pats 170-199, including in particular Part 178, Section 2010, for antioxidants and stabilizers.

During vis-breaking by reaction of the feedstock resin during extrusion with an organic peroxide, the decomposition of the peroxide yields a trace amount of organic material (organoleptics) that affects the odor and taste characteristics of the finished resin.

The first step in the controlled rheology reaction is the decomposition of the peroxide. This occurs in a homolytic fashion yielding two alkoxy radicals. The alkoxy radical can itself abstract a hydrogen atom from the polymer or undergo rearrangement. Hydrogen abstraction by an alkoxy group yields t-amyl alcohol (TAA) and TBA for DTAP and DTBPH, respectively.

Rearrangement of the alkoxy radical yields acetone and an ethyl or methyl radical depending on the starting peroxide. Just as is the case for the alkoxy radical, the alkyl radical is free to abstract a hydrogen from the polypropylene resin. Hydrogen abstraction by an alkyl radical is more pronounced for DTAP owing to a greater tendency to rearrange after decomposition. This forms lower quantities of residual alcohol in the finished polypropylene resin.

The abstraction of a hydrogen atom from the polymer backbone, either by an alkoxy or an alkyl radical leads to a beta scission rearrangement of the polymer. This reaction shortens the polymer chain length (lower MW) yielding a polymer with higher melt flow characteristics.

In accordance with this invention, significant improvements in odor have been demonstrated in a series of odor studies conducted on polypropylene processed by reactive extrusion technique with di-t-amyl peroxide selected as the organic peroxide. The improvement in odor is directly related to the molecular structure of the organic peroxide, as shown by comparison of di-t-amyl peroxide with other peroxides.

In order to achieve improved odor/taste characteristics in the finished polypropylene product, the organoleptics must be either present in lower concentration, bound in the polymer, or intrinsically have more agreeable odor/taste properties.

DTAP contains a lower active oxygen content than does DTBPH. In order to achieve the same Theological effect a greater quantity of DTAP must be used in comparison to DTBPH. Theoretical active oxygen contents of 9.6 for DTAP vs. 11.02 for DTBPH indicate that it takes approximately 20% more DTAP to achieve the same degree of rheology modification as DTBPH. In practice, the vis-breaking amount of di-t-amyl peroxide is suitably in the range from 200 to 2000 parts by weight per million parts by weight of propylene polymer, and the temperature effective in decomposing di-t-amyl peroxide is suitably in the range from 320° F. (160° C.) to 600° F. (316° C.).

Since a greater amount of DTAP is required for the vis-break reaction and there are no differences in the finished properties of a CR resin produced using DTAP com-pared to DTBPH, any improvements in odor/taste must be derived from the odor/taste characteristics of organoleptics. When one compares the odor of TBA and TAA it is readily apparent that TBA has a disagreeable, astringent odor while TAA has a sweet, fruity odor. This difference in the properties of the organoleptic species leads to improved odor/taste in the finished resin.

An analysis of the physical properties of DTAP reveals some additional benefits of this dialkyl peroxide. DTAP is a liquid at room temperature with a freezing point below −50° C. A low freezing liquid does not require heat traced piping and will not freeze during winter months. The U.S. Department of Transportation classifies DTAP as a OP8 hazard permitting transport and storage in relatively large packages.

In terms of peroxide reactivity, DTAP and DTBPH show very similar performance owing to the similarity in their 1 0-hour half-life temperatures. This permits DTAP to be used in an essentially “drop-in” fashion as a substitute for DTBPH and does not require significant changes to the extruder heat profile.

The advantages and the important features of the present invention will be more apparent from the following example. All parts and percentages are by weight unless otherwise specified.

### EXAMPLE

### Odor Comparison of Controlled Rheology Resins Containing DTAP or DTBPH

A series of odor studies was carried out for polypropylene resins vis-broken with di-t-amyl peroxide (DTAP) in one composition and with 2,5-dimethyl,2,5-di-t-butylperoxyhexane (DTBPH), a peroxide used in the prior at to produce controlled rheology polypropylene, in another. A polypropylene resin manufactured by Solvay was chosen as the base resin (MI=12). The extrusion trials were run on vented 53 mm twin screw extruder. The throughput rate was approximately 350 lbs./hr. with barrel temperatures between 390 and 410° F. (199 and 210° C.).

In a convenient compounding technique, peroxides were added to the extruder as “masterbatch” comprising the liquid peroxide mixed with the base polypropylene resin. The masterbatch was added under a nitrogen purge. Peroxide loadings and the corresponding melt flow data are provided in Table 1.

TABLE 1
Peroxide Loading

| Sample | Peroxide Loading | Melt Flow Index |
|---|---|---|
| Base Resin | none | 12 |
| DTAP (low break) | 500 ppm | 33 |
| DTAP (high break) | 1200 ppm | 55 |
| DTBPH (low break) | 400 ppm | 36 |
| DTBPH (high break) | 700 ppm | 49 |

Odor studies as per ASTM E544-75/88 were carried out to determine the intensity and hedonic tone of the vis-broken products compared to the baseline polypropylene. The baseline data consist of the “barefoot” resin extruded without organic peroxide. Independent odor evaluations were carried out by St. Croix Sensory, Inc. An odor panel consisting of 10 persons was asked to judge odor characteristics of vis-broken polypropylene. Odor trials were carried out on samples at ambient, 20° C. (68° F.), and elevated, 60° C. (140° F.), temperatures. The results of the odor trials are shown in Tables 2 and 3.

The Odor Intensity is the relative strength of the odor above the Recognition Threshold (suprathreshold). The intensity of an odor is referenced on the ASTM Odor Referencing Scale described in ASTM E544-75/88, Standard Practice for Referencing Suprathreshold Odor Intensity. The IITRI Dynamic Dilution Binary Olfactometer (Butanol Wheel) is the method St. Croix Sensory uses for the procedure of odor intensity referencing.

The odor intensity of an odor sample is compared to the odor intensity of a series of concentrations of the reference odorant, which is butanol. An olfactometer delivers the butanol in air to eight glass sniffing ports that make up a series of increasing concentrations of the butanol. The series has an increasing concentration ratio of 2 (binary scale).

The odor intensity of an odor sample is expressed in parts per million of butanol. A larger value of butanol means a stronger odor, but not in a simple numerical proportion. The average value of the odor evaluation is the reported intensity for the odor sample.

Hedonic Tone is a measure of the pleasantness or unpleasantness of an odor sample. The hedonic tone is independent of its character. An arbitrary, but common, scale for ranking odors by hedonic tone is the use of a 21 point scale, wherein +10 is “pleasant”, 0 is “neutral”, and −10 is “unpleasant”.

The assignment of a hedonic tone value to an odor sample by an assessor is subjective to the assessor, who uses personal experience and memories of odors as a referencing scale.

The average value of the odor evaluation is the reported hedonic tone for the odor sample.

TABLE 2
Results of Odor Trials (Sample Temperatures @ 20° C.)

| Sample | Odor Intensity | Hedonic Tone |
|---|---|---|
| Baseline (unextruded) | 25 | +1.0 |
| Baseline (extruded) | 45 | +0.5 |
| DTAP (MI-33) | 80 | +0.6 |
| DTBPH (MI-36) | 110 | −0.5 |
| DTAP (MI-55) | 150 | −0.4 |
| DTBPH (MI-49) | 170 | −0.5 |

TABLE 3
Results of Odor Trials (Sample Temperature @ 60° C.)

| Sample | Odor Intensity | Hedonic Tone |
|---|---|---|
| Baseline (unextruded) | 55 | −1.5 |
| Baseline (extruded) | 475 | −1.9 |
| DTAP (MI-33) | 65 | −0.5 |
| DTBPH (MI-36) | 70 | −0.7 |
| DTAP (MI-55) | 120 | −1.3 |
| DTBPH (MI-49) | 140 | −1.8 |

The odor results clearly show that polypropylene modified with DTAP has improved odor characteristics in both intensity and hedonic tone when compared to polypropylene modified with DTBPH at both trial temperatures.

In particular, the odor intensity for polypropylene processed to MI 33 with DTAP measured at 20° C. is 30 points lower (80 vs. 110) than that measured for a resin modified to a similar melt flow with DTBPH. In addition, the hedonic tone shows more than a full point improvement towards pleasant (+0.6 vs. −0.5). This improvement is realized even though approximately 20 percent more DTAP is used in the masterbatch formulation in order to achieve a similar break.

Similar results were observed when vis-breaking was carried out to a greater extent (compare the last two lines of Table 2).

Results at 60° C. show an interesting change in the human perception of odor. Intensity actually decreases for like samples. For example, the DTAP (MI-33) sample yields an intensity of 80 at 20° C., while at 60° C. the intensity is 65.

Surprisingly, both the intensity and the hedonic tone of this sample are better (lower intensity, less negative hedonic tone) than the unmodified extruded base resin.

In view of the many changes and modifications that can be made without departing from principles underlying the invention, reference should be made to the appended claims for an understanding of the scope of the protection to be afforded the invention.

1. A shaped article of manufacture comprising a polymer composition comprising a propylene polymer having a melt flow index in the range from 4 to 120 decigrams/minute, di-t-amyl peroxide, and t-amyl alcohol, wherein said article is selected from the group consisting of articles for food contact and articles for medical applications, whereby said article has agreeable odor characteristics.

2. The article of claim 1 wherein the propylene polymer is selected from the group consisting of homopolymeric polypropylene and copolymers of propylene with other copolymerizable monomers wherein greater than about 50% by weight of the copolymer is comprised of propylene moieties.

3. The article of claim 2 wherein the propylene polymer is homopolymeric polypropylene.

4. The article of claim 2 wherein the propylene polymer is a copolymer of propylene and at least one comonomer selected from the group consisting of ethylene, butylene, and 4-methyl-pentene-1.

5. The article of claim 1 wherein the di-t-amyl peroxide is present in a range of from 200 to 2000 parts by weight per million parts by weight of the propylene polymer.

6. The article of claim 1 wherein said article is selected from the group consisting of packaging films, candy wrappers, bottles and containers for foods, bottles and containers for pharmaceuticals, and medical syringes.

7. The article of claim 1 wherein said article has a high surface to volume ratio.

8. The article of claim 7 wherein said article is a film.

9. A method of manufacturing a shaped article comprising the steps of:
A) mixing a propylene polymer having a melt flow index in the range from 1 to 20 decigrams/minute with a vis-breaking amount of di-t-amyl peroxide,
B) heating the mixture at a temperature effective to decompose the di-t-amyl peroxide until the melt flow index is in the range of from 4 to 120 decigrams/minute, and
C) shaping an article comprising a mixture comprising the propylene polymer having a melt flow index in the range from 4 to 120 decigrams/minute, di-t-amyl peroxide, and t-amyl alcohol, wherein said article is selected from the group consisting of articles for food contact and articles for medical applications, whereby said article has agreeable odor characteristics.

10. The method of claim 9 wherein the propylene polymer is selected from the group consisting of homopolymeric polypropylene and copolymers of propylene with other copolymerizable monomers wherein greater than about 50% by weight of the copolymer is comprised of propylene moieties.

11. The method of claim 10 wherein the propylene polymer is homopolymeric polypropylene.

12. The method of claim 10 wherein the propylene polymer is a copolymer of propylene and at least one comonomer selected from the group consisting of ethylene, butylene, and 4-methyl-pentene-1.

13. The method of claim 9 wherein the di-t-amyl peroxide is present in a range of from 200 to 2000 parts by weight per million parts by weight of the propylene polymer.

14. The method of claim 9 wherein said article is selected from the group consisting of packaging films, candy wrappers, bottles and containers for foods, bottles and containers for pharmaceuticals, and medical syringes.

15. The method of claim 9 wherein said article has a high surface to volume ratio.

16. The method of claim 15 wherein said article is a film.

17. A method for improving the odor/taste characteristics in a finished article of manufacture comprising a polymer of propylene, wherein the method comprising the steps of:
A) mixing a propylene polymer having a melt flow index in the range from 1 to 20 decigrams/minute with a vis-breaking amount of di-t-amyl peroxide,
B) heating the mixture at a temperature effective to decompose the di-t-amyl peroxide until the melt flow index is in the range of from 4 to 120 decigrams/minute, and C) shaping an article comprising a mixture comprising the propylene polymer having a melt flow index in the range from 4 to 120 decigrams/minute, di-t-amyl peroxide, and t-amyl alcohol, wherein said article is selected from the group consisting of articles for food contact and articles for medical applications, whereby said article has agreeable odor characteristics.

18. The method of claim 17 wherein said article is selected from the group consisting of packaging films, candy wrappers, bottles and containers for foods, bottles and containers for pharmaceuticals, and medical syringes.

19. The method of claim 17 wherein said article has a high surface to volume ratio.

20. The method of claim 19 wherein said article is a film.
